(19) United States
(12) Patent Application Publication
(10) Pub. No.: US 2015/0363467 A1
(43) Pub. Date: Dec. 17, 2015

(54) PERFORMING AN INDEX OPERATION IN A MAPREDUCE ENVIRONMENT

(71) Applicant: HEWLETT-PACKARD DEVELOPMENT COMPANY, L.P., West, Houston, TX (US)

(72) Inventors: Zhao CAO, Beijing (CN); Dongzhe MA, Beijing (CN); Shimin CHEN, Beijing (CN); Min WANG, Beijing (CN)

(21) Appl. No.: 14/763,810

(22) PCT Filed: Jan. 31, 2013
(86) PCT No.: PCT/CN2013/000105

§ 371 Date: Jul. 27, 2015

(51) Int. Cl. G06F 17/30

(52) U.S. Cl. CPC G06F 17/30474; G06F 17/30457; G06F 17/30336

(57) ABSTRACT

A method for performing an index operation in a MapReduce environment is provided. An execution plan is generated based on a conceptual job input by a user, wherein said conceptual job comprises an index operator, a mapper and a reducer and said execution plan is generated to minimize an execution cost based on characteristics of the index operator. The execution plan is converted to MapReduce jobs and the MapReduce jobs are provided to a runtime component for execution.

### BACKGROUND

Large scale data analysis is playing an important role in both industry (e.g., web or network monitoring log analysis for various applications, click-stream analysis for marketing and advertising applications, etc.) and academia (e.g., bioinformatics, simulation, etc.). MapReduce is a well-known framework for data-intensive applications, which uses a simple programming model and hides the complexity of parallelization, data transfer, scalability, fault tolerance and so on. In this simple programming model, a scan centric approach is used to execute a job. That is to say, the input is split into blocks and each block is assigned to a map task to process data. Consequently, all the input data is scanned to finish the job. The results of map tasks are then re-distributed to several nodes based on grouping keys of a well-defined Reduce function.

A wide range of big data processing operations require accessing multiple data sources selectively. Example data sources may include large knowledge bases, inverted indices, spatial indices, indexed user profile data, and many other external data sources. Their common characteristics are similar to that of an index: Given a lookup criterion, a data source will return zero, one, or more values. Such a data source can be modeled as an index.

### BRIEF DESCRIPTION OF THE DRAWINGS

The accompanying drawings illustrate various examples of various aspects of the present disclosure. It will be appreciated that the illustrated element boundaries (e.g., boxes, groups of boxes, or other shapes) in the figures represent one example of the boundaries. It will be appreciated that in some examples one element may be designed as multiple elements or that multiple elements may be designed as one element. In some examples, an element shown as an internal component of another element may be implemented as an external component and vice versa.

FIG. 1 is a process flow diagram for a method of performing an index operation in a MapReduce environment according to an example of the present disclosure;

FIG. 2 is a process flow diagram for another method of performing an index operation in a MapReduce environment according to another example of the present disclosure;

FIG. 3A and FIG. 3B are structures of an index operator according to an example of the present disclosure;

FIG. 4A and FIG. 4B are schematic diagrams of index operators integrated with mappers and reducers according to an example of the present disclosure;

FIG. 5 is a block diagram of a system capable of performing an index operation in a MapReduce environment according to an example of the present disclosure;

FIG. 6 is a schematic diagram of a feasible plan space of an index operator according to an example of the present disclosure;

FIG. 7 is a schematic diagram of dynamic re-optimization for a conceptual job according to an example of the present disclosure; and

FIG. 8A and FIG. 8B are schematic diagrams for dynamically changing execution plans by reusing the intermediate result of already finished tasks according to an example of the present disclosure.

### DETAILED DESCRIPTION

Systems and methods for performing an index operation in a MapReduce environment are disclosed. An index operation, as generally described herein, involves looking up a dataset that is usually consisted of records and columns and retrieving records that satisfy preset conditions or statistics thereof. A MapReduce environment generally has a number of mappers and reducers. As is appreciated, a mapper maps input key/value pairs to a set of intermediate key/value pairs. Mappers are the individual tasks that transform input records into intermediate records. The transformed intermediate records do not need to be of the same type as the input records. A given input pair may be mapped to zero or more output pairs. A reducer reduces a set of intermediate values which share a key to a usually smaller set of values. It is appreciated that MapReduce lacks efficient and flexible support for index operation. An example of the systems and methods disclosed herein can produce an optimal execution plan for a MapReduce job related to an index operation by considering a number of optimization strategies including caching, index locality and etc. Another example of the systems and method disclosed herein can further dynamically reevaluate and re-optimize the execution plan during running based on collected statistics about the involved indices.

In the following, examples of the present disclosure are described in detail with reference to the drawings.

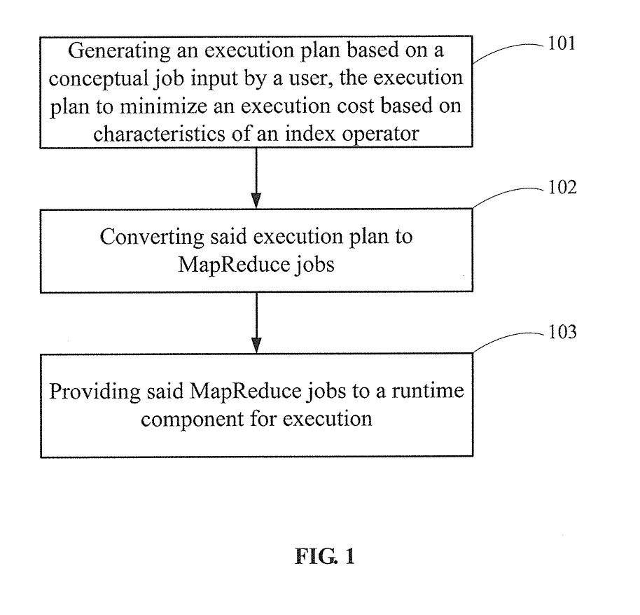

Referring now to FIG. 1, a process flow diagram for a method of performing an index operation in a MapReduce environment according to an example of the present disclosure is described. At block 101, an execution plan is generated based on a conceptual job input by a user. The conceptual job comprises an index operator, a mapper and a reducer. In an example, the execution plan is generated to minimize an execution cost of executing the conceptual job in a given MapReduce environment. Minimizing the execution cost can be based on at least one of input locality and characteristics of the index operator, such as, for example, index locality, repartitioning of input of the index operator, and caching of index, as described in detail below.

As used in this disclosure an index operator is used to perform an index operation and its structure will be described in more detail below. As used in this disclosure, a job which mixes mapper/reducer and index operators (i.e., comprising an index operator, a mapper and a reducer) is called a conceptual job. Generally, a conceptual job is a MapReduce job in the form of <[I], M, [I], [R], [I]>, where [I] refers to a sequence of index operators, and M and R refer to Mapper and Reducer respectively. Index operators are executed one by one in order. [ ] also means this operator is optional in a job. As used in this disclosure, an execution plan is a series of MapReduce jobs {j₁, . . . , jᵢ, . . . j_{J}}, where J is the number of jobs in this execution plan. The first job j₁ consumes the input set in the conceptual job and each job feeds its output to its subsequent job as an input.

At block 102, the execution plan is converted to MapReduce jobs of a corresponding MapReduce runtime environment such as Hadoop. At block 103, the MapReduce jobs are submitted or provided to a runtime component for execution.

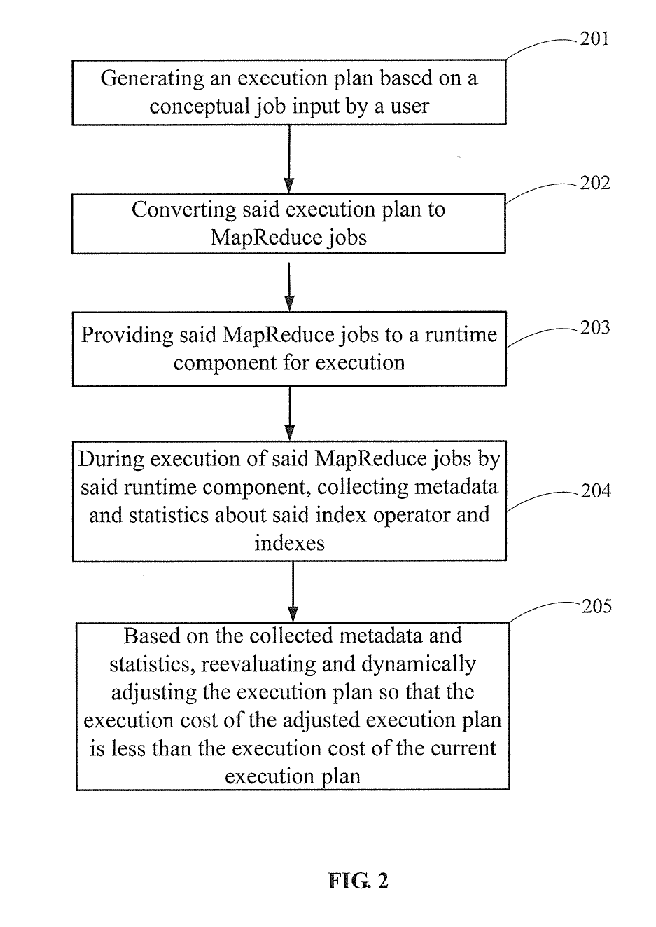

Referring now to FIG. 2, a process flow diagram for another method of performing an index operation in a MapReduce environment according to another example of the present disclosure is described. As shown, blocks 201-203 are the same as blocks 101-103 and will not be described in detail herein. At block 204, during execution of MapReduce jobs by the runtime component, metadata and statistics about the index operator and indices can be collected. At block 205, based on the collected metadata and statistics, the execution plan is reevaluated and dynamically adjusted so that the execution cost of the adjusted execution plan is less than the execution cost of the current execution plan.

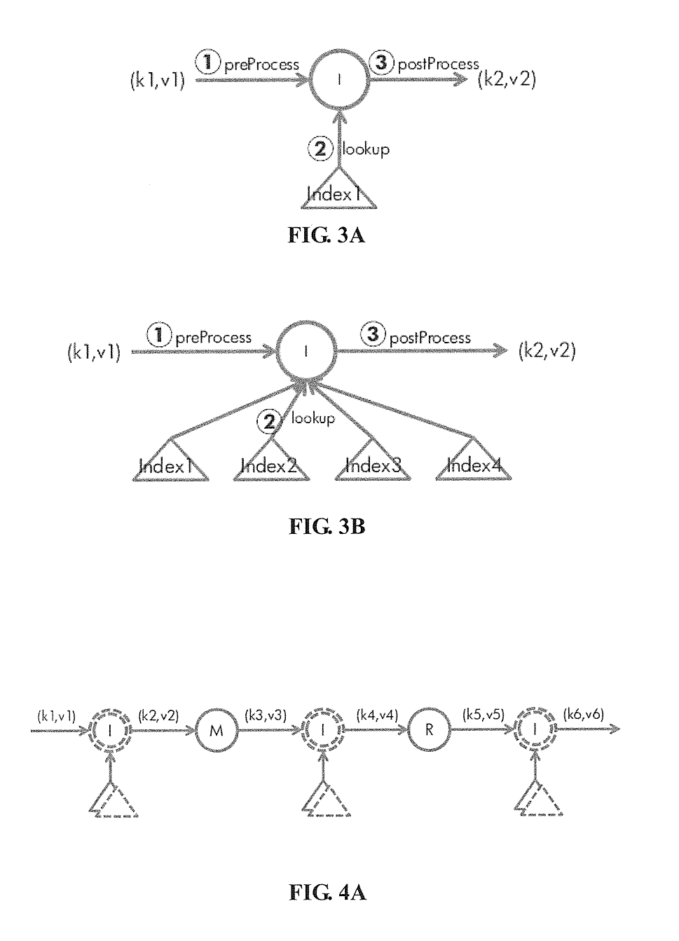

Attention is now directed to FIGS. 3A and 3B, which show a structure of an index operator according to an example of the present disclosure. The structure shown in FIG. 3A follows a natural process of using an index, which may include the following steps: (1) extracting a key from an input record and filtering the record or eliminating any unnecessary part(s) of the record, which can be represented as “preprocess” in FIG. 3A; (2) looking up an index and obtaining the results, which can be represented as “lookup” in FIG. 3A; and (3) optionally filtering the lookup results and combining portions of the input record with the lookup results, which can be represented as “postProcess” in FIG. 3A. In many cases, more than one index could be added to a single index operator, as shown in FIG. 3B, where a triangle represents an index. This would allow a single input record to search multiple indices.

As described above, a concept job may comprise a combination of index operators, mappers and reducers and thus an index operator needs to interface with a mapper or a reducer. In order to facilitate such interfacing, the MapReduce paradigm can be leveraged to represent a record with a key-value pair for an index operation, as shown by (ki,vi) in FIG. 3A and FIG. 3B. Input and output of the above three steps are as follows:
preProcess: <k1, v1>→<k2, v2,{[ik₁], . . . , [ik_{I}]}>
lookup: {[ik₁], . . . , [ik_{I}]}→{[ik₁, [iv₁]], . . . , [ik_{I}, [iv_{I}]]}
postProcess: <k2, v2, {[ik₁, [iv₁]], . . . , [ik_{I}, [iv_{I}]]}>→[<k3, v3>]

Here, I is the number of indices to be accessed. The preProcess step extracts I set of index keys {ikⱼ} (j=1, . . . I) from the input <k1, v1>, where {ikⱼ} is an array with zero or multiple keys for the j-th index. The preProcess step also converts the input to <k2, v2>, e.g., by performing a projection. The lookup step fetches values {ivⱼ} from index j for index key ikⱼ, where { } means that zero or multiple results can be returned for every key. The postProcess step merges <k2, v2> with the index lookup results to obtain a set of <k3, v3>. Note that the preProcess step and the postProcess step can perform filtering operations without generating any output.

All these three steps can be customized. As is appreciated, the preProcess step and the postProcess steps are often job specific, but the lookup step is typically fixed for every type/format of index and is independent of the jobs. Thus, according to an example of the present disclosure, a user only needs to specify logics of the first and third steps. The index lookup step could be conducted by the system implicitly.

According to an example of the present disclosure, a standard interface based on a primitive function is provided for an index operator. That is to say, an index operator is a primitive operator with key-value inputs and outputs. In this way, index operators can be easily integrated with mappers and reducers. The output of an index operator can be fed into another index operator, a mapper, or a reducer and vice versa.

An example of such an interface of index operator in Java is as follows:

public abstract class IndexOperator{
public abstract boolean preProcess (Writable key, Writable value,
IndexInput keys) ;
public abstract void postProcess(Writable key, Writable
value,IndexOutput indexValues,
outputCollector<Writable, Writable> output);
}

Wherein, in the preprocess step, key and value are the key and value of an input record respectively. IndexInput is a collector that collects the index key (indexKey) for indexId-th index. The content of key and value could be reset here. For example, some attributes of a value could be removed, just like the projection operator in a relational database. Meanwhile, the record <key, value> may be eliminated from further processing by returning false, just like the selection operator in a relational database. In the postProcess step, key and value are the output key and value of preProcess respectively. IndexOutput is a collector that contains the index values of each key after index lookup, and output is a collector to hold the <key, value> pair of postProcess results.

As described above, with this interface, a user only needs to specify the preProcess and postProcess steps, while the lookup step can be implemented in a wrapper class per index type or format.

An example for index operation is presented below to further illustrate the preprocess, index lookup and postprocess steps. In this example, spatio-temporal topic patterns are mined from a large number of Twitter tweets collected over a period of several months, wherein every tweet includes a twitter account, a timestamp and a tweet message. The mining task includes the following operations: (1) a city of a twitter user is obtained by searching a user profile index using the twitter account as the key. A user profile is previously crawled from the twitter web site and contains information such as address, bio, followee list. (2) A topic category of the tweet is computed by extracting keywords from the message and calling an external knowledge-base service. (3) Top-k popular topics are selected for each combination of a city and a time range; and (4) An event database (i.e. index) is looked up to get the events happened at the given city and time range to enrich the results.

With regard to the first operation of this spatio-temporal topic pattern mining for example, the input of the first operation is a string record including a twitter account, a timestamp, a message, etc. The preProcess step can extract the account as an index key and discard all the other fields except the account, the timestamp, and the message. After retrieving the profile information from the user profile index, the postProcess step can extract a city from the user profile and merge it with the result of the preprocess step to construct an output record of the twitter account, the timestamp, the message and the city.

A specific Java implementation of an index operator for this example is as follows, wherein a user profile index is used. It is appreciated that those skilled in the art can implement the index operator in any programming language and the present example and disclosure are not limited in this regard.

```
public class UserProfileIndexOperator extends IndexOperator{
      public boolean preProcess(Writable key, Writable value,
      IndexInput keys) {
            String tweet = {(Text) value},toString( );
            String amount = extractAmount(tweet);
            keys.put( [symbol]  account);
            tweet = removeOtherFields(tweet);
      }
      public void postProcess(Writable key, Writable value,
      IndexOutput indexValues,
                        OutputCollector<Writable,
                        Writable> output) {
            String tweet = {(Text) value},toString( );
            String profile = indexValues.get.(0).getAll( ) [0];
            String city = extractCity(profile);
            String result = tweet.append(city);
            output.collect(key, result);
      }
```

[symbol]

indicates data missing or illegible when filed

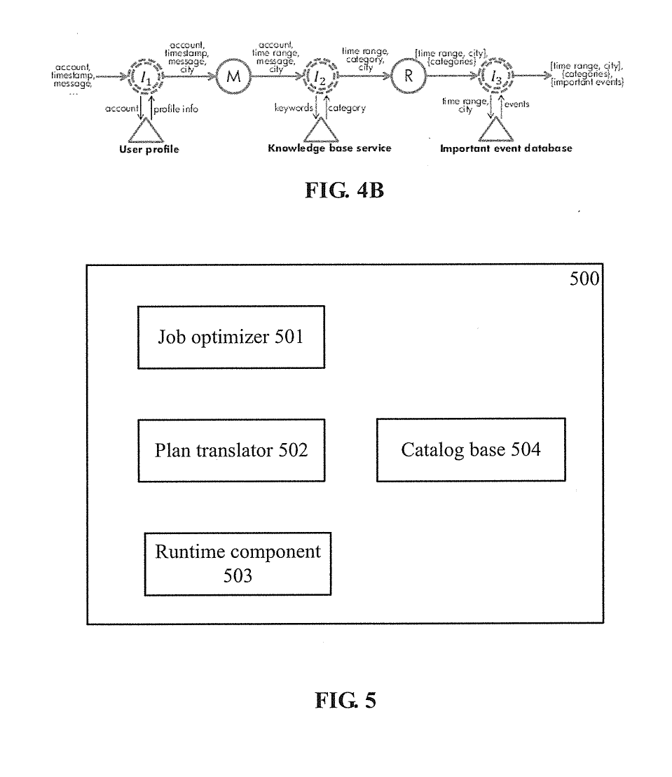

With reference to FIGS. 4A and 4B now, FIG. 4A shows integration of index operators with mappers and reducers according to an example of the present disclosure. As shown in FIG. 4A, zero or multiple index operators could be placed: (i) in front of a mapper to perform index lookups based on an input to the mapper; (ii) between a mapper and a reducer to perform index lookup based on an output of the mapper; and (iii) after a reducer to perform index lookup based on an output of the reducer.

FIG. 4B shows a more detailed diagram of FIG. 4A specific to the above described spatio-temporal mining example. As can be seen, the group-by and top-k aggregation computation in operation (3) fits the MapReduce programming model very well and three index operators are used to implement the remaining operations (1), (2) and (4).

It is appreciated that Hadoop is a type of MapReduce system. In order to form a conceptual job, the JobConf class of Hadoop is extended to IndexJobConf, keeping all the features of JobConf, In addition, IndexJobConf provides the following APIs:

addHeadIndexOperator, which adds an index operator before a mapper.

addBodyIndexOperator, which inserts an index operator between map and reduce functions.

addTailIndexOperator, which appends an index operator after a reduce function.

The following is a Hadoop driver of the above described example about spatio-temporal topic pattern mining using IndexJob-Conf, where the UserProfileIndexOperator is added before the Mapper to look up the user profile index.

```
public class JobDriver{
      public void [symbol]  ( ) {
            IndexJobConf iConf = new IndexJobConf( );
            UserProfileIndexOperator userProfileIdxOp =
            new UserProfileIndexOperator( );
            userProfileIdxOp.addIndex(“corp.labs.Indexaccessor.-
            UserProfileAccessor”,
                        “ [symbol] ,localheat,9160,userprofile”);
            iConf.addHeadIndexOperator(userProfileIdxOp);
            iConf.setMapper(KeyWordExtractMapper.class);
            TopicCategoryIndexOperator topicCategoryIdxOp = new
            TopicCategoryIndexOperator( ),
            topicCategoryIdxOp.addIndex(“corp.labs.indexaccessor.-
            TopicCategoryAccessor”,
                        “services.external.TopicCategoryService”);
            iConf.addBodyIndexOperator(topicCategoryIdxOp);
            iConf.setHeducer(TimechangeCityGroupReducer.class);
            ImportantEventIndexOperator importantEventIdxOp =
            new ImportantEventIndexOperator( );
            importantEventIdxOp.addIndex(“prop.labs.indexaccessor.-
            ImportantEventAccessor”,
                        “ [symbol] ,15.154.147.160,3216,importantEvent”);
            iConf.addTailIndexOperator(importantEventIdxOp);
            iConf.submit( );
      }
} [symbol]
indicates data missing or illegible when filed
```

Referring now to FIG. 5, a block diagram of a system capable of performing an index operation in a MapReduce environment according to an example of the present disclosure is described. The system 500 comprises a job optimizer 501 which is configured to generate an execution plan based on a conceptual job input by a user; a plan translator 502 which is configured to convert said execution plan from the job optimizer 501 to MapReduce jobs; and a runtime component 503 which is configured to execute MapReduce jobs provided by the plan translator 502. The system 500 further comprises a catalog base 504 which is configured to collect and store metadata and statistics about the index operator and indexes during execution of MapReduce jobs by the runtime component 503.

The catalog base 504 contains statistics about indices and index operators. The system may collect statistics for every index and every index operator at the preProcess, lookup, and postProcess steps. The following lists some examples of statistics collected in these three steps.

| Term | Where | Description |
|---|---|---|
| sᵢₙ | preProcess | Average size of input records |
| γₚᵣₑ | preProcess | Ratio of number of output records to |
| | | number of input records |
| sₚᵣₑ | preProcess | Average size of output records |
| n^{s}_{K} | preProcess | Average number of index key(s) extracted |
| | | from an input record for index i |
| s^{s}_{K} | index i | Average size of index keys |
| s_{V}ⁱ | index i | Average size of index results. If more than |
| | | one values are returned in an index search, |
| | | s_{V}ⁱ represents the size of the entire |
| | | result set. |
| tⁱ | index i | Average time of index lookup |
| γₚₒₛₜ | postProcess | Ratio of number of output records to |
| | | number of input records |
| sₚₒₛₜ | postProcess | Average size of output records |
| θᵢ | Input data | Local redundancy of the index key for index i |
| Θᵢ | Input data | Global redundancy of the index key for index i |

According to an example of the present disclosure, the job optimizer 501 may generate an execution plan that minimizes the execution cost based on the conceptual job input by the user. For example, the job optimizer 501 can minimize the execution cost based on at least one of input locality, index locality, repartitioning of input of the index operator, and caching of index.

In an example, a plan for an index operator is that preProcess, lookup, and postProcess can be implemented as chained mappers if the index operator is placed before a mapper or between a mapper and a reducer. The preProcess, lookup, and postProcess steps can be implemented as chained reducers if the index operator is placed after a reducer.

In another example, because there may exist many duplicate index lookups from the same machine node, therefore a cache can be used to optimize the execution plan and avoid duplicated index lookup for the same key. Specifically, a cache can store the input-output pairs that are already probed in an index and when there is a hit in the cache, the cache entry will be returned immediately, thus avoiding the index access.

In yet another example, repartitioning of the input can be considered to optimize the execution plan. Sometimes, there may exist many duplicate index lookup keys across the machine nodes in a MapReduce job, and it may be more efficient to first group the records with the same index key together and then perform only one index lookup for each distinct key. Suppose that an index is already partitioned based on a partition function. The system described herein can use an additional MapReduce job to partition the input data based on the given partition function, where the number of partitions is determined by the number of partitions in the index.

According to another example, index locality and/or input locality can be considered to optimize the execution plan.

A MapReduce system typically tries to co-locate a mapper with its assigned input data chunk in order to reduce the data transfer cost. However, there may be more than one data source in question, including the input data and the indices. As such, there may exist the following cases: (i) Data size of index lookup is smaller than the input data size; (ii) Data size of index lookup is larger than the input data size. To minimize the data transfer cost, for the former case, computation can be co-located with the input data. While for the latter case, it may be better to co-locate computation with the index if possible. In practice, a large index is usually stored with hash or range partitions on multiple machine nodes. These existing partitions could be exploited for the index locality optimization. In the above described example of tweet mining, since the user profile record is quite larger than tweet and is partitioned based on a twitter account, the user profile can be co-located with the corresponding tweets for each partition to save index lookup cost.

In the implementation based on Hadoop described above, the Hadoop TaskTracker is a thread that lives on each node of the Hadoop cluster and communicates with the JobTracker through the Heartbeat protocol. Given a node n is available to run a task, this TaskTracker announces its availability through a heartbeat message to indicate that it is ready for the next task. When JobTracker receives a heartbeat message from a TaskTracker declaring it is ready for the next task, the job tracker selects the next available job in the priority list and determines which task is appropriate for the TaskTracker to execute.

However, if the job is running with index locality, each task is assigned an input split and an index partition. The scheduler first attempts to match a task with a node that meets the index locality. When no task can be matched with a node that meets the index locality, the system will attempt to find a task in the node closest to the index partition. In this context, the closest node would be a node on the same rack where the index is stored. Finally, if a node in the same rack cannot be found, then the alternative is to find a node in another rack. Once this process is completed, the actual task is assigned to the target TaskTracker. Because when the index to be accessed is local to the node executing the task, the TaskTracker node is alleviated from having to fetch the required index value from a remote node. The cost model described below will balance whether to use input split locality or index locality. It is appreciated that the present disclosure is not limited to Hadoop but can be applicable to any MapReduce environment.

Given an index operator, an optimal plan that minimizes the execution cost can be found. According to an example, the feasible plan space can be explored and the cost of each plan is calculated. Then, the plan with the minimal cost can be selected.

The cost of a plan p can include the following components:

Input transferring (denoted as cost_{transfer}(p)). It includes the cost such as moving an input chunk from its storage node to a remote node to meet index locality.

System added shuffling (denoted as cost_{shuffle}(p)). This is relative to shuffling of a user defined reducer. It mainly contains the cost of re-partitioning an input (an original input or a result of preProcess) using a system added reducer.

Index lookup (denoted as costₗₒₒₖᵤₚ(p)). It includes a cost of transferring an index key, index value and fixed cost of each index lookup C, such as the cost to build a network connection and message overhead.

To combine the time cost and network cost together, a factor α can be introduced, which measures the number of bytes could be transferred in the given time of index lookup.

α=tⁱ/NetworkThroughput (1)

Wherein, NetworkThroughput is the network throughput in the cluster. And the total cost of plan p is:

cost(p)=cost_{transfer}(p)+cost_{shuffle}(p)+α*costₗₒₒₖᵤₚ(p) (2)

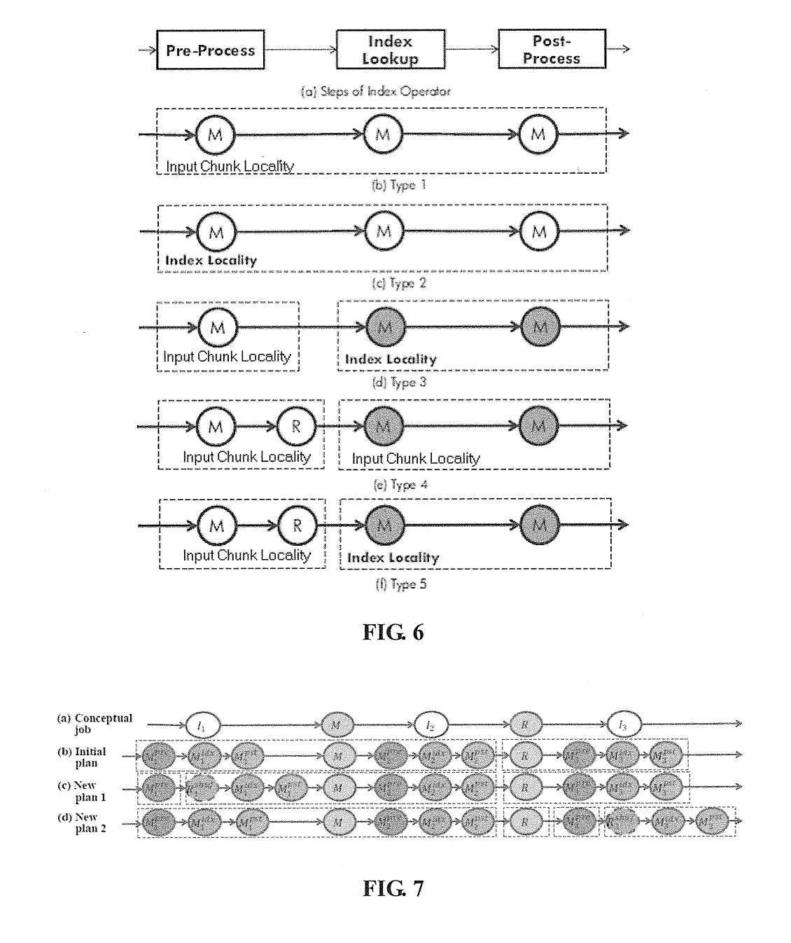

Given an index operator, whose number of input record is nᵢₙ, the feasible plan set includes five types of plans, as shown in FIG. 6:

Type 1. This type of plan (shown in FIG. 6b) converts each index operator into three mappers, then chains the mappers before a reducer into a ChainMapper, and chains the reducer and its following mappers as a ChainReducer. Finally the job is run using input chunk locality.

For a type 1 plan, the cost_{transfer} is zero because the job is run using input chunk locality. As no additional shuffle is injected, the system added shuffling cost is zero. The index lookup cost for this plan is:

$${cost}_{lookup} ( p ) = {n}_{in} * {γ}_{pre} * {\sum }_{1 \leq i \leq I}^{ } \{ {n}_{K}^{i} * ( 2 * {s}_{K}^{i} + {s}_{V}^{i} + C ) * ( 1 - {θ}_{i} ) \} \qquad ( 3 )$$

Type 2. Suppose that the input is co-partitioned with the x-th index of an index operator, as shown in FIG. 6c, similar with type 1, the index operator is converted to three mappers, then the mappers before the reducer are chained into a ChainMapper, and the reducer and mappers after the reducer are chained as a ChainReducer. However, finally, the job is run using index locality for index x. If more indexes are co-partitioned with the input, there will be more plans in this plan set and a plan with the minimal cost can be selected.

For a type 2 plan, the cost_{shuffle}(p) is zero. The input transferring cost is:

cost_{transfer}(p)=nᵢₙ*sᵢₙ (4)

The index lookup cost is:

$${cost}_{lookup} ( p ) = {n}_{in} * {γ}_{pre} * {\sum }_{{1 \leq i \leq I}_{i \neq x}}^{ } \{ {n}_{K}^{i} * ( 2 * {s}_{K}^{i} + {s}_{V}^{i} + C ) * ( 1 - {θ}_{i} ) \} \qquad ( 5 )$$

Type 3. Suppose that the input is co-partitioned with an index x of the index operator, as shown in FIG. 6d. The pre-process step is converted to a mapper and this job is map-only, which means no reducer for this job. Then, the index lookup and postProcess steps are translated into two mappers in another job. Finally, these mappers are chained into a chain mapper which can be run using index locality. If more than one index are co-partitioned with the input, there will be more plans in this plan set.

For a type 3 plan, the system added shuffling cost is zero. The input transferring cost is:

cost_{transfer}(p)=nᵢₙ*γₚᵣₑ*sₚᵣₑ (6)

The index lookup cost is the same as Equation 5.

Type 4. Suppose that an index x is partitioned based on a known function f, as shown in FIG. 6e. This plan first converts the preprocess step into a mapper and appends a system-added reducer which shuffles the record based on the function f and the key of the index x. If more than one index is partitioned, there will be more plans in this plan set.

For a type 4 plan, the input transferring cost is 0. The system added shuffling cost is:

cost_{shuffle}(p)=nᵢₙ*γₚᵣₑ*sₚᵣₑ (7)

The index lookup cost is:

$${cost}_{lookup} ( p ) = {n}_{in} * {γ}_{pre} * \{ {\sum }_{{1 \leq i \leq I}_{i \neq x}}^{ } \{ {n}_{K}^{i} * ( 2 * {s}_{K}^{i} + {s}_{V}^{i} + C ) * ( 1 - {θ}_{i} ) \} + {n}_{K}^{x} * ( 2 * {s}_{K}^{x} + {s}_{V}^{x} + C ) * ( 1 - {θ}_{x} ) \} \qquad ( 8 )$$

Wherein, cₓ is the cache hit rate of the index x. Once grouped by the key of the index i, the index lookup and postProcess steps are converted to mappers, respectively. Finally these mappers are chained together and the job is run by using input split locality.

Type 5. Different with type 4, in the third step, the plan shown in FIG. 6f chains the subsequent mappers together and runs the job using index locality of index x. Consequently, the system added shuffling cost is the same as Equation 7. The input transferring cost is the same as Equation 6. The index lookup cost is the same as Equation 5.

As described above in regard to FIG. 5, based on the collected statistics, the execution plan can be reevaluated and dynamically adjusted. FIG. 7 shows dynamic re-optimization for a conceptual job according to an example of the present disclosure. Specifically, along with running of jobs, more statistics can be collected, and the current plan can be reevaluated periodically, for example once every in map tasks or r reduce tasks are finished. If the current running job is at the Map phase, index operators before the reducer of the current job can be extracted. Otherwise, the current job is at the Reduce phase, and the index operator(s) that appears after the reducer can be extracted. Then, the job optimizer 501 can be invoked to generate a new optimized plan for the extracted operator(s). Note that there are two types of new plans: (1) a completely new plan that cannot reuse the intermediate results of the already finished tasks; and (2) an adjustment of the old plan that can reuse intermediate results of the already finished tasks.

After a new plan is generated for the extracted index operators, the new plan is returned for running if the cost of the new plan is less than the current plan by a certain threshold; otherwise, the current plan is kept running.

Once it is determined to run the new plan, an approach can involve discarding the intermediate results of the already finished tasks and re-running the job with the new plan. However, this will lead to a waste of computation resources and delay job completion. According to an example, the new plan can reuse the intermediate results of the already finished tasks so as to reduce execution time.

In practice, the old job may be stopped at the Map phase or at the Reduce phase, as shown in FIG. 7. In FIG. 7a-7d, the superscript pre represents preprocessing, idx represents index lookup, shuf represents shuffling and pst represents postprocessing. FIG. 7a shows a conceptual job with three index operators I₁, I₂ and I₃. FIG. 7b shows an initial execution plan for this conceptual job, which converts every index operator into three chained mappers for the preprocessing, index lookup and postprocessing operations. FIG. 7c and FIG. 7d shows changing the execution plan in the middle of the map phase and in the middle of reduce phase respectively. In FIG. 7a-FIG. 7d, every dotted rectangle includes a set of steps that can be performed in a single map task or reduce task and the R^{shuf} nodes are used to repartition inputs.

As shown in FIG. 7b, for the initial plan, the chained mappers are first run, during which statistics can be collected and it may be determined that a new plan which repartitions the input based on the index key might be better, as shown in FIG. 7c. The reducer R₁^{shuf} in FIG. 7c is used to repartition the output of the preprocess step based on the index key and the execution plan can be said to “stop at the map phase”. The old job is converted into two MapReduce jobs and reusing of the intermediate result in this case will be described in detail below. In another case, all tasks before the Reducer have already been finished, and the chained reducer (indicated by an ellipse with R) is running, as shown in FIG. 7b. It may be determined at this phase that it might be better to repartition the output of the preprocess step based on the index key and the execution plan thus “stops at the reduce phase”. The new plan is as shown in FIG. 7d. The reducer R₃^{shuf} in FIG. 7d is used to repartition the output of the preprocess step based on the index key and the ChainReducer is split into two MapReduce jobs.

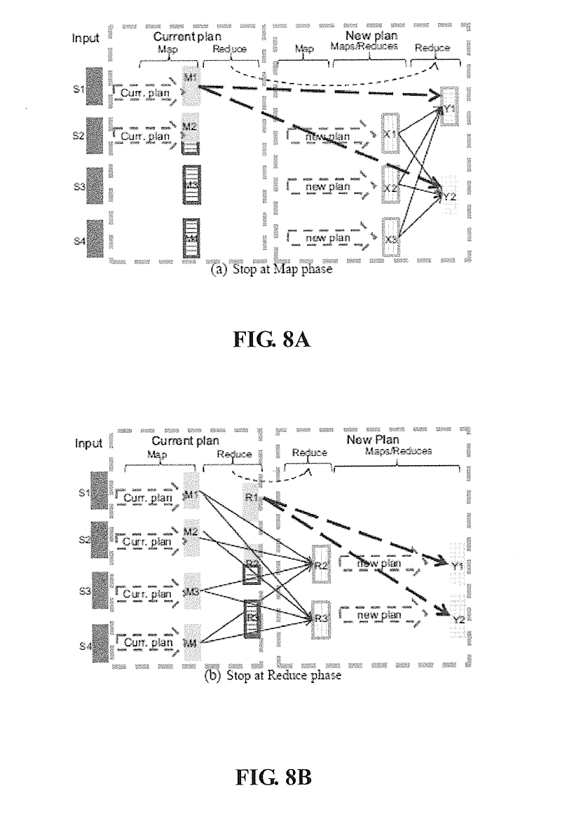

With reference to FIG. 8 now, FIG. 8 shows dynamically changing execution plans while reusing the intermediate results according to an example of the disclosure. FIG. 8a illustrates a case where a new plan is generated when the old job is running at the map phase, wherein S1, S2, S3 and S4 are four data chunks of the four map tasks respectively. Each of these map tasks could be in one of the following three states: (1) already finished, such as M1, (2) still running, such as M2, and (3) waiting to be scheduled to run, such as M3 and M4. For simplicity and efficiency of processing, the intermediate results of the already finished tasks such as M1 can be reused, but the partial result of still running tasks such as M2 can be discarded. Without loss of generality, the new plan corresponding to the map phase of the old job may consist of one or more jobs, but the reducer of the last job is the same as the reducer of the old job (linked with thin dotted arrow in FIG. 8a). Specifically, the new plan is first applied to the selected input chunks such as S2, S3 and S4 in FIG. 8a, which correspond to the map tasks of the old job that are still running or waiting to run. Then, the reduce tasks of the new plan (such as Y1 and Y2) can be run. It is appreciated that reduce tasks such as Y1 and Y2 need to fetch records not only from map tasks right before the reducer of the new plan (such as X1, X2 and X3), but also fetch records from previous already-finished map tasks (such as M1) of the old job, as indicated by the thick dotted line in FIG. 8a.

FIG. 8b illustrates another case where a new plan is generated when the old job is running at the reduce phase. Note that the reduce phase can include a reducer and a series of map tasks. Similar to the case in FIG. 8a, the reduce task may also be in one of the following three states: (1) already finished, such as R1, (2) still running, such as R2, and (3) waiting to be scheduled to run, such as R3. The reducer of the old job is still kept as a reducer in the new plan (linked with thin dotted arrow in FIG. 8b) and the map tasks in the Maps/Reduces shown in FIG. 8b may be changed to a series of MapReduce jobs in the new plan. In order to reuse the intermediate results, the reduce tasks of the reducer in the new plan (e.g. R2′ and R3′) are first run and their outputs are then fed into to the new plan. Finally, the results of the new plan (e.g. Y1 and Y2) are merged with the results of the old plan (e.g. R1) which has already finished, as shown by the thick dotted arrow line in FIG. 8b.

The methods and systems disclosed herein can be utilized in many MapReduce-based index related applications to provide flexible and efficient support for index operations. An example of such applications is index-based joins, which are extensively used in relational database systems. For example, index nested loop joins are often chosen over scan-based joins when an index exists on an input table and the join selectivity is high. Bitmap indices can achieve good join performance in read-mostly environments, such as data warehouses. Examples of the systems and methods presented herein can help reduce manual efforts in adapting/customizing MapReduce data flows for joining two or more tables. Another example may be spatial applications, such as k-nearest neighbor join between two spatial data sets, in which a large number of web applications (e.g., search engines, news providers, social networks) utilize location information about a user to provide more personalized user experience. Location information is analyzed, e.g., for modeling user preferences and for categorizing locations. These applications usually rely on spatial indices for data processing.

As yet another application example, text analysis often requires index operations as well. Examples of text analysis can include acronym expansion using a precomputed acronym dictionary, concept extraction based on a knowledge base such as Wikipedia, and keyword search using inverted indices. These indices are often intended to capture the aggregate human knowledge or the current state of the entire web, and can be quite large. In addition, the systems and methods disclosed herein can also help to integrate a data analysis carried out by an organization which may not have sufficient resources or technologies to obtain all the necessary data on its own. An external data source owned by a third party organization and this kind of external data service can also be modeled as an index that requires selective accesses. Still another application example might be a combination of multiple data sources in a big data analysis. For example, click stream analysis often combines location information obtained from IP addresses, user profile information, web page content information, and web access logs. In general, this can be regarded as a multi-way join operation. With the aid of the present disclosure, a single MapReduce job can be utilized to access multiple indexed data sources, thereby reducing the number of jobs and their related job overhead.

From the above depiction of the implementation mode, the above examples can be implemented by hardware, software or firmware or a combination thereof. For example the various methods, processes, modules and functional units described herein may be implemented by a processor (the term processor is to be interpreted broadly to include a CPU, processing unit, ASIC, logic unit, or programmable gate array etc.) The processes, methods and functional units may all be performed by a single processor or split between several processors. They may be implemented as machine readable instructions executable by one or more processors. Further the teachings herein may be implemented in the form of a software product. The computer software product is stored in a storage medium and comprises a plurality of instructions for making a computer device (which can be a personal computer, a server or a network device, etc.) implement the method recited in the examples of the present disclosure.

The figures are only illustrations of an example, wherein the modules or procedure shown in the figures are not necessarily essential for implementing the present disclosure. Moreover, the sequence numbers of the above examples are only for description, and do not indicate an example is more superior to another.

Those skilled in the art can understand that the modules in the device in the example can be arranged in the device in the example as described in the example, or can be alternatively located in one or more devices different from that in the example. The modules in the aforesaid example can be combined into one module or further divided into a plurality of sub-modules.

What is claimed is:

1. A method for performing an index operation in a MapReduce environment, comprising:
generating an execution plan based on a conceptual job input by a user, wherein said conceptual job comprises an index operator, a mapper and a reducer and said execution plan is generated to minimize an execution cost based on characteristics of the index operator;
converting said execution plan to MapReduce jobs; and
providing said MapReduce jobs to a runtime component for execution.

2. The method of claim 1, further comprising:
during execution of said MapReduce jobs by said runtime component, collecting statistics about said index operator and indexes.

3. The method of claim 1, wherein the characteristics of the index operator comprise index locality, repartitioning of input of said index operator, and caching of index.

4. The method of claim 1, wherein said index operator can be located before a mapper, between a mapper and a reducer, or after a reducer.

5. The method of claim 1, wherein minimizing the execution cost is based on input locality.

6. The method of claim 2, further comprising:
based on the collected statistics, reevaluating and dynamically adjusting the execution plan so that the execution cost of the adjusted execution plan is less than the execution cost of the current execution plan.

7. The method of claim 1, wherein a standard interface based on a primitive function is provided for said index operator so that a result of said index operator can be fed to a mapper or reducer and vice versa.

8. A system for performing an index operation in a MapReduce environment, comprising:
a job optimizer to generate an execution plan based on a conceptual job input by a user, wherein said conceptual job comprises an index operator, a mapper and a reducer and said execution plan is generated to minimize an execution cost based on characteristics of the index operator; and
a plan translator to convert said execution plan from said job optimizer to MapReduce jobs.

9. The system of claim 8, wherein said system further comprises a catalog base to collect and store statistics about said index operator and indexes during execution of said MapReduce jobs by said runtime component.

10. The system of claim 8, wherein the characteristics of the index operator comprise index locality, repartitioning of input of said index operator, and caching of index.

11. The system of claim 8, wherein said index operator can be located before a mapper, between a mapper and a reducer, or after a reducer.

12. The system of claim 8, wherein said job optimizer minimizes the execution cost based on input locality.

13. The system of claim 9, wherein said job optimizer is further to reevaluate and dynamically adjust the execution plan based on the collected statistics, so that the execution cost of the adjusted execution plan is less than the execution cost of the current execution plan.

14. The system of claim 8, wherein a standard interface based on a primitive function is provided for said index operator so that a result of said index operator can be fed to a mapper or reducer and vice versa.
